(19) United States
(12) Patent Application Publication
(10) Pub. No.: US 2011/0231388 A1
(43) Pub. Date: Sep. 22, 2011

(54) E-BOOK READ APPARATUS AND OPERATION THEREOF

(75) Inventors: Gary KUNG, Santa Ana, CA (US); Ping-Shun ZEUNG, Santa Ana, CA (US)

(73) Assignee: I/O INTERCONNECT, LTD., Santa Ana, CA (US)

(21) Appl. No.: 13/025,770

(22) Filed: Feb. 11, 2011

Related U.S. Application Data
(60) Provisional application No. 61/315,416, filed on Mar. 19, 2010.

(51) Int. Cl. G06F 17/30

(52) U.S. Cl. 707/711; 707/E17.049

(57) ABSTRACT

An operation method for an e-book is provided that links to an index database of the e-book, wherein the index database has a plurality of index objects and a plurality of index information corresponding to each of index objects. In addition, the index formation shows page numbers of a plurality of pages having the index objects in the e-book. Then, a plurality of briefs of the pages recorded in each of index information are obtained, and added in to corresponding index information for rebuilding index database. When one of index objects is selected on an index screen, the updated index information of the selected index object is showed on the index screen by the present invention.

### CROSS-REFERENCE TO RELATED APPLICATION

This application claims the priority benefit of U.S. provisional application Ser. No. 61/315416, filed on Mar. 19, 2010. The entirety of the above-mentioned patent application is incorporated herein by reference and made a part of this specification.

### BACKGROUND

1. Technical Field

The present invention generally relates to an e-book and particularly, to an operation method for index information of the e-book.

2. Description of the Related Art

Since environmental consciousness increases, all kinds technologies of e-book, no matter of software or hardware, have large scale growth. The e-ink or normal plan monitor is employed in the e-book for displaying, so as to save the paper. In addition, because the e-book is digital data, a user bringing an e-book read apparatus amounts to bring many books in the same time. It is so convenient for the user.

In some e-books, some noun indexes are listed. FIG. 1 shows a diagram of index screen of prior known e-book. Referring FIG. 1, the index screen 100 of prior known e-book has a plurality of character words, such 102. In prior known index screen 102, the page numbers of a plurality of pages of each of index character words, such like 104. A user just depends on the showed page numbers and turns to the corresponding page, thus the corresponding index character word can be found.

However, some index character words correspond to large amounts of pages, and the pages are distributed in different chapters and sections. For example, the index character word 106 corresponds to two pages. Thus, a user must turn to the corresponding page respectively, so as to determine which information of two pages is needed information by user. In another words, a index character word corresponds to more pages, the user would spend more time to find needed page.

### BRIEF SUMMARY

Thus, an e-book read apparatus is provided by the present invention for showing an index screen for a user, so as to find needed information fast.

In addition, an operation method for an-e-book is further provided by the present invention, and the operation method provides more detail index screen for a user, so as to guide the user to find needed information in shortest time.

The present invention provides an e-book read apparatus comprising a processor, a screen, a storage unit and an index engine. The storage unit saves an e-book having an index database comprising a plurality of index objects and a plurality of index information corresponding to the index objects. Wherein, the index information shows the page numbers of a plurality of pages having the index objects. The storage unit is coupled to the processor. Therefore, the processing obtains the e-book from the storage unit, and shows the e-book on the screen. In particular, the index engine is linked to the index database and the e-book, so as to obtain briefs of the pages recorded in the index information from the e-book, and add the obtained briefs into the corresponding index information for rebuilding the index database.

In one embodiment of the present invention, the e-book read apparatus further comprises a detector coupled to the screen. Wherein, the screen can be a touch control screen. When the screen displays the said index objects and one of the index objects is touched, the detector outputs corresponding detection signal to the index engine. Meanwhile, the updated index information of selected index object is showed on the screen by the index engine.

From another viewpoint, the present invention further provides an operation method for an e-book, comprising linking to a index database of the e-book, and the index database has a plurality of index objects and a plurality of index information of the corresponding index objects. In addition, the index information shows page numbers of a plurality pages having the index objects in the e-book. Then, a plurality of briefs of the pages recorded in the index information are obtained form the e-book, and the briefs are added into the corresponding index information for rebuilding the index database. When one of the index objects is selected on a index screen, the updated index information of selected index object is showed on the index screen.

In one embodiment of the present invention, the index objects are character words, production names, or factory names.

In addition, contents of updated index information comprise page numbers of pages recorded in the index information, titles of chapters and sections or articles. Furthermore, the updated index information further shows the paragraph having of the articles in the pages recorded in the index information. Wherein, the index objects are marked form corresponding paragraph.

Since the present invention can rebuild the index database, so as to show updated index information in the index screen. Thus, users can obtain needed information fast.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a diagram of index screen of prior known e-book.

FIG. 2 shows a system diagram of an e-book read apparatus according to one preferred embodiment of the present invention.

FIG. 3 shows a flow chart diagram of operation method for an e-book according to one preferred embodiment of the present invention.

FIG. 4 shows a diagram of an index screen according to one preferred embodiment of the present invention.

FIG. 5 shows a diagram of an index screen according to one selected embodiment of the present invention.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

Since conventional index screen of the e-book only list the page numbers of corresponding pages, a user is difficult to know other information. To solve this problem, the present invention shows an index screen which except lists the page number also other information. Therefore, the user can find needed page fast depending on the information listed on the index screen.

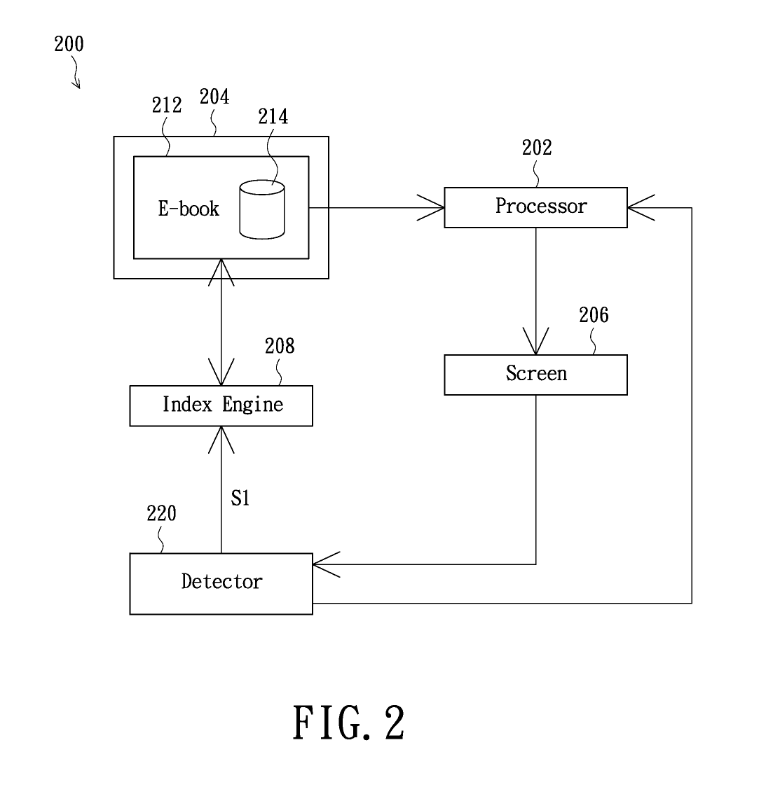

FIG. 2 shows a system diagram of an e-book read apparatus according to one preferred embodiment of the present invention. Referring the FIG. 2, the e-book read apparatus 200 provided by the embodiment comprises a processor 202, a storage unit 204, a screen 206 and an index engine 208. Wherein, the storage unit 202 saves an e-book 212 and couples to the processor 202. Thus, the processor 202 obtains the e-book 212 from the storage unit 204 and shows the e-book on the screen 206.

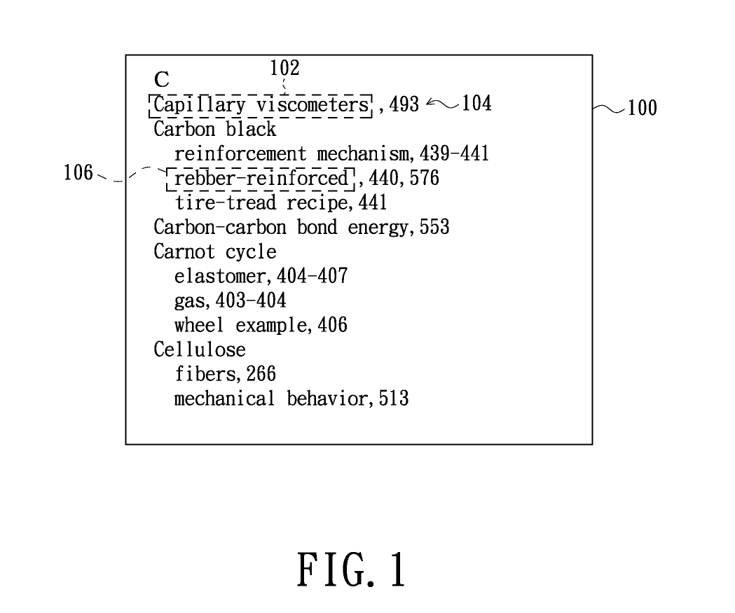

In this embodiment, the e-book 212 has an index database 214 having a plurality of index objects and a plurality of index information corresponding to each index object. In some embodiment, the index objects are character words showed in FIG. 1. In other embodiments, the index objects are production names or company name. In addition, each index information corresponding to each index object is, for example, the page number as showed in FIG. 1.

In particular, the index engine 208 links with the e-book 212 and the index database 214. In this embodiment, the index engine 208 can be a firmware and be written in the processor 202. However, in some selective embodiments, the index engine 208 can be embodied by application software, and be installed in the storage unit 204.

In addition, the screen 206 can be a touch control screen. In these embodiments, the e-book read apparatus 200 further comprises a detector 220. The detector 220 is coupled to the screen 206 for detecting whether or not the screen 206 is touched and detecting the touched position on the screen 206. The detector 202 transmits a detection result to the processor 202 for performing corresponding operation procedure.

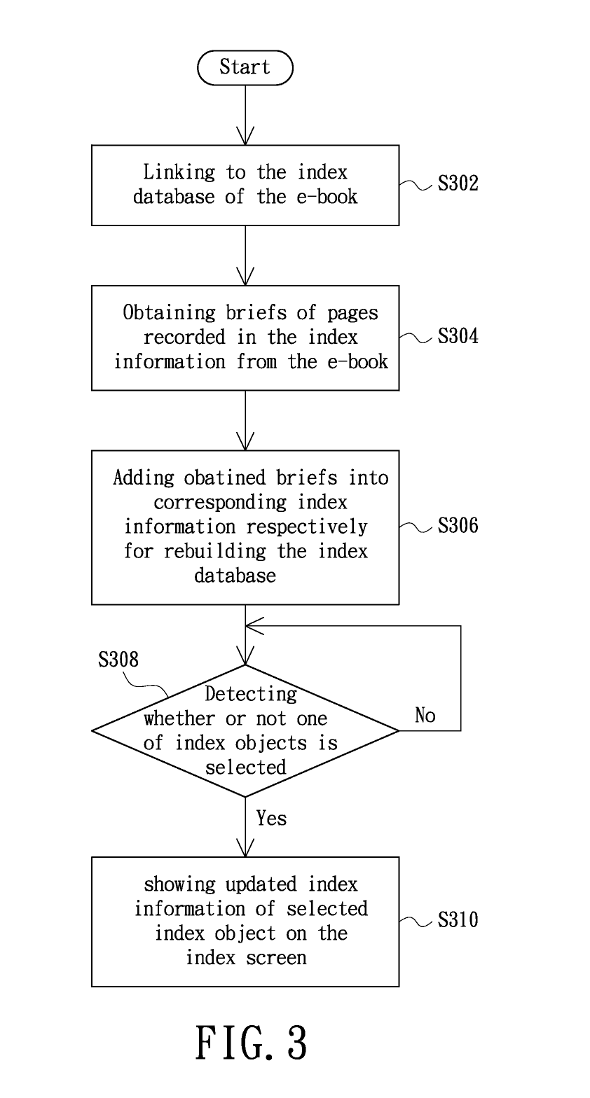

FIG. 3 shows a flow chart diagram of operation method for an e-book according to one preferred embodiment of the present invention, suitable for the index engine 208 in FIG. 2. Referring FIGS. 2 and 3, in the embodiment, the index engine 208 first links to the index database 214 of the e-book 212 (S302). Then, the index engine 208 searches corresponding pages from the e-book 212 according the page numbers recorded in the index information, and obtains the briefs of searched pages (S304). The briefs can be chapters and sections belonged to each page. However, in some periodicals or catalogs, the typesetting structure is not basis on chapters and sections. Therefore, in these embodiments, the briefs obtained by the index engine 208 are the titles of articles in each page.

When the index engine 208 obtains briefs of needed pages, the briefs are added into corresponding index information respectively for rebuilding the index database 214 (S306). In addition, when the user operates the e-book read apparatus 200 and a index screen having the index information is showed on the screen 206, the detector 202 detects whether or not one of index objects on the screen 206 is selected (S308). When one of index objects on the screen 206 is selected. The detector 220 outputs corresponding detection signal S1 to the index engine 208. Therefore, the index screen shows updated index information of selected index object (S310).

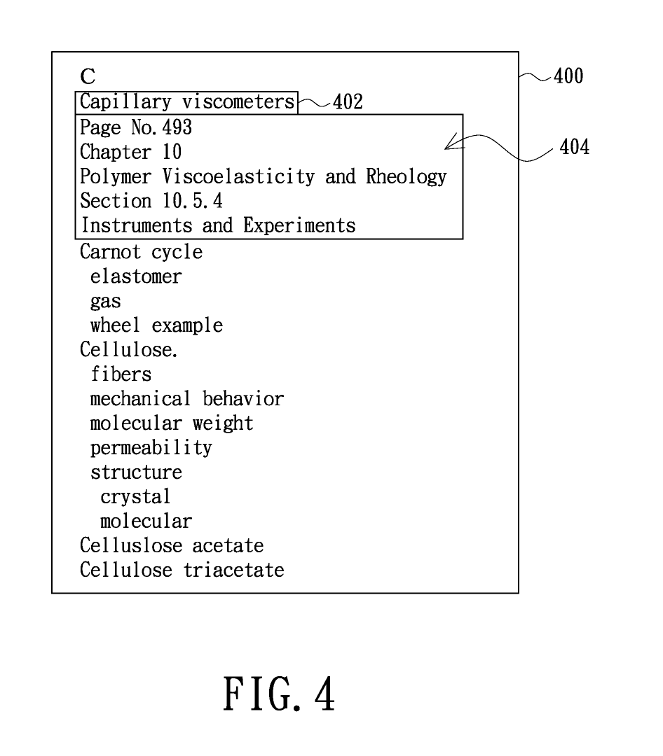

FIG. 4 shows a diagram of an index screen according to one preferred embodiment of the present invention. Referring to FIG. 4, in the embodiment, when one of index object on the index screen 400 is selected such like index object 402, the updated index information 404 is showed. The content of the updated index information 404 includes the page numbers of corresponding pages having the index object 402 and briefs of the corresponding pages, for example, the chapters and sections information. Furthermore, as mentioned above, the briefs of the pages can also be the titles of the articles in these pages.

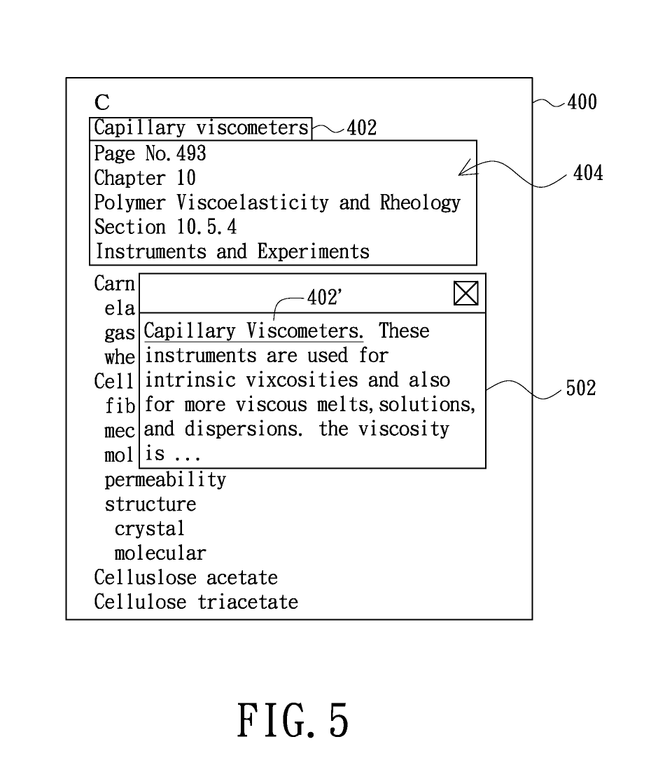

FIG. 5 shows a diagram of an index screen according to one selective embodiment of the present invention. Referring FIG. 5, in this selective embodiment, when the user further selects the updated index information 404, the index screen 400 shows an information frame. In the information frame, a paragraph having the index object 402 in the article belonged to the corresponding page is showed. In addition, in the paragraph showed in the information frame 502, the index object 402 is marked in particularly.

In summary, in the present invention can obtain the briefs of related pages from the e-book according to the original data in the index database. These briefs are added into the index information of corresponding index object for rebuilding the index database. When the index objects are selected, the updated index information are showed on the index screen. Therefore, the user can find needed information fast.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An e-book read apparatus, comprising:
a storage unit, storing an e-book having an index database which has a plurality of index objects and a plurality of index information corresponding to the index objects, wherein the index information shows page numbers of a plurality of pages which has the index objects;
a processor, coupled to the storage unit for obtaining the e-book;
a screen, coupled to the processor for showing the e-book; and
an index engine, linked to the index database and the e-book for obtaining a plurality of briefs of the each of pages recorded in each of index information, so as to add the briefs to the corresponding index information for rebuilding the index database.

2. The e-book read apparatus as claimed in claim 1, wherein the screen is a touch control screen.

3. The e-book read apparatus as claimed in claim 2, further comprising a detector coupled to the screen for detecting whether or not the touch control screen is touched and the touched position on the touch control screen.

4. An operation method of an e-book, comprising:
linking an index database of the e-book, wherein the index database has a plurality of index objects and a plurality of index information corresponding to the index objects so as to show page numbers of a plurality pages which has the index objects in the e-book;
obtaining a plurality of briefs of the pages corresponding to each of index information from the e-book;
adding the briefs to corresponding information respectively for rebuilding the database; and
showing one of updated index information on a index screen, when one of objects corresponding to the showed updated index information is selected on the index screen.

5. The operation method as claimed in claim 4, wherein the index objects are at least one of a plurality of character words, a plurality of production names and a plurality of factory names.

6. The operation method as claimed in claim 4, wherein matters of the updated index information comprises page numbers and chapters and sections of the pages recorded in the index information.

7. The operation method as claimed in claim 4, wherein matters of the updated index information comprises a plurality of paragraphs which has the index objects in the pages of the index information, and each of index objects is marked from corresponding paragraph.
